(19) United States
(12) Patent Application Publication
(10) Pub. No.: US 2014/0124500 A1
(43) Pub. Date: May 8, 2014

(54) INSULATED HEATER

(71) Applicants: Chih-Chang WEI, New Taipei City (TW); Etsuro HABATA, New Taipei City (TW)

(72) Inventors: Chih-Chang WEI, New Taipei City (TW); Etsuro HABATA, New Taipei City (TW)

(73) Assignee: BETACERA INC.

(21) Appl. No.: 13/668,325

(22) Filed: Nov. 5, 2012

(51) Int. Cl. H05B 3/10

(52) U.S. Cl. 219/552

(57) ABSTRACT

An insulated heater includes a heating unit, two thermal diffusion units and a heat conduction glue. The heating unit includes two electrode plates and at least one PTC heating plate. The PTC heating plate is sandwiched between two electrode plates. The thermal diffusion unit includes a corrugated metal fin and two heat conduction plates, and the corrugated metal fin is sandwiched between two heat conduction plates. Each thermal diffusion unit is attached to one of the electrode plates via the heat conduction plate, and the heat conduction glue is spread between each electrode plate and the thermal diffusion unit attached to the electrode plate. The thermal resistance between the thermal diffusion unit and the electrode plate can decrease by directly binding the thermal diffusion unit and the electrode plate with the heat conduction glue.

### BACKGROUND

1. Technical Field

The present invention relates to a warm air heating structure, especially to an insulated heater directly assembled by heat conduction glue.

2. Related Art

The heating rows are usually used in clothes dryer, laundry machine, car auxiliary heater, bathroom dryer, electric radiator, or dish dryer, etc. The conventional heating row provides loads to heat the resistor by connecting two electrodes to two sides of a resistor, and then conducting the heat generated by the resistor to two pairs of fins (the fins are attached to two electrodes). The heat can be emitted to the air via the fins.

Current heating row usually uses back adhesive as the binding interface between the fins and the electrodes in order to facilitate the assembling. The drawback is that, the back adhesive layer is a thin membrane with glue on both sides, so the heat transmitted from the electrodes to the fins should be via two layers of glue and one layer of thin membrane. The back adhesive layer increases the thermal resistance during the heat conduction process, which results in the heat conduction inefficiency for the conventional heating row. Furthermore, the insufficient adhesion of the back adhesive layer also makes the components easy to come off.

### BRIEF SUMMARY

The present invention provides an insulated heater, and the structure of the heater makes the heat transmitting efficiency of each components better than the conventional technique.

The present invention provides an insulated heater, which includes a heating unit, two thermal diffusion units and a heat conduction unit. The heating unit includes two electrode plates and at least one PTC (Positive Temperature Coefficient) heating plate, the PTC heating plate is sandwiched between the two electrode plates, the thermal diffusion unit includes a corrugated metal fin and two heat conduction plates, the corrugated metal fin is sandwiched between the two heat conduction plates, the thermal diffusion units attaches to one of the electrode plates via the heat conduction plates, and the heat conduction glue is spread between the electrode plates and the thermal diffusion units attached to the electrode plates.

Preferably, the PTC heating plate is covered by the heat conduction glue. The side of the heat conduction plate is covered with the heat conduction glue. The composition of the heat conduction glue is silicon gel. The composition of the heat conduction glue includes plastics. The composition of the heat conduction glue includes Teflon. The composition of the heat conduction glue includes polyamide. The composition of the heat conduction glue includes epoxy. The composition of the heat conduction glue includes ceramic powder. The surface of the corrugated metal fin is provided with a repression groove. The corrugated metal fin is bent and has a plurality of peaks which are arranged in two lines being opposite to each other, and a convection slot is provided between the two peaks. The corrugated metal fin is bent and has a plurality of peaks which are arranged in two lines being opposite to each other, and each peak of one of the lines is provided with a convection slot respectively. The surface of the PTC heating plate is processed by spraying metal. The surfaces of the electrode plates are processed by anodic treatment.

The insulated heater according to the present invention decreases the thermal resistance between the thermal diffusion unit and the electrode plate by directly binding the thermal diffusion unit and the electrode plate with the heat conduction glue, thereby improving the heat transmitting efficiency of every components of the heater, and the shortcoming of the conventional technique can be overcome as well.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded perspective view of an insulated heater of the first embodiment in accordance with the present invention;

FIG. 2 is a perspective schematic view of the insulated heater of the first embodiment in accordance with the present invention;

FIG. 3 is a longitudinal sectional view of the insulated heater of the first embodiment in accordance with the present invention;

FIG. 4 is a lateral sectional view of the insulated heater of the first embodiment in accordance with the present invention;

FIG. 5 is a schematic view of the insulated heater of the second embodiment in accordance with the present invention;

FIG. 6 is a longitudinal sectional view of the insulated heater of the second embodiment in accordance with the present invention;

FIG. 7 is a schematic view of another pattern of the second embodiment of the insulated heater in accordance with the present invention;

FIG. 8 is a schematic view of the third embodiment of the insulated heater in accordance with the present invention;

FIG. 9 is a schematic view of a second pattern of the third embodiment of the insulated heater in accordance with the present invention; and

FIG. 10 is a schematic view of a third pattern of the third embodiment of the insulated heater in accordance with the present invention.

### DETAILED DESCRIPTION

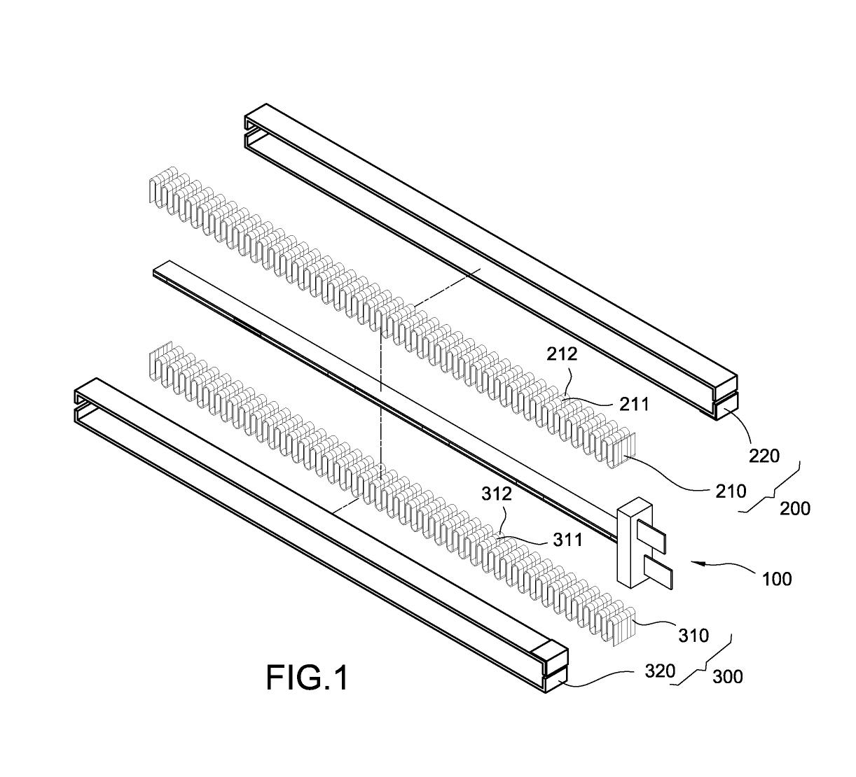

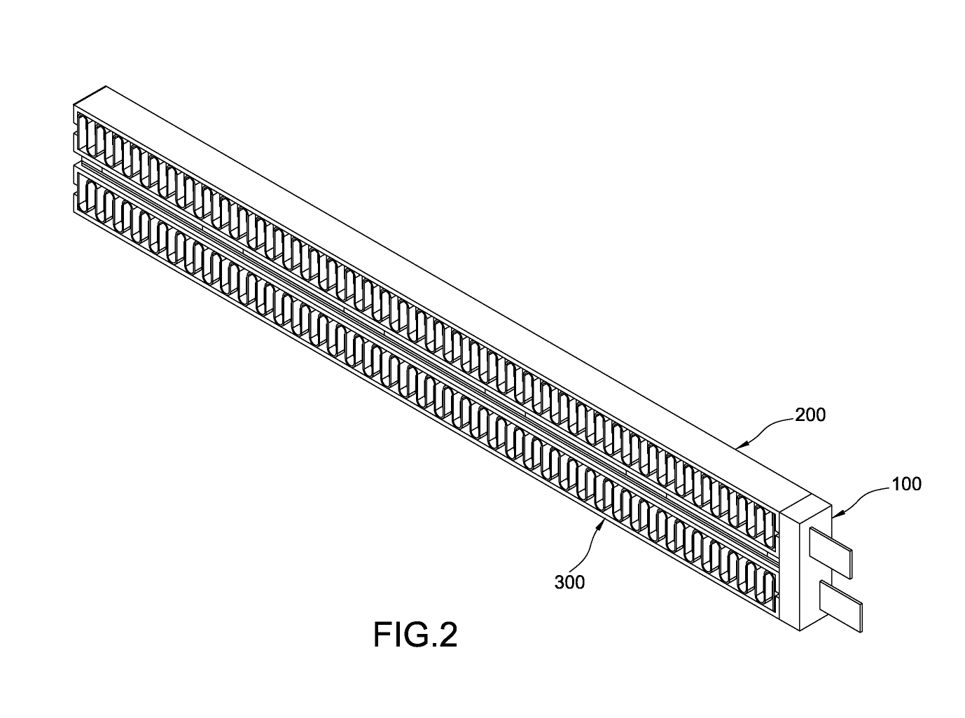

Please refer to FIGS. 1 and 2. The first embodiment according to the present invention provides an insulated heater, which includes a heating unit 100, two thermal diffusion units 200/300, and a heat conduction glue 400. The two thermal diffusion units 200/300 are attached to the opposite sides of the heating unit 100, respectively. The liquid state heat conduction glue 400 is spread between each thermal diffusion unit 200/300 and the heating unit 100. The thermal diffusion units 200/300 and the heating unit 100 are stuck together after the heat conduction glue 400 solidifies. Thus, the heat generated from the heating unit 100 can be transmitted to each thermal diffusion unit 200/300 via the heat conduction glue 400, and the heat will further be emitted to the air via each thermal diffusion unit 200/300.

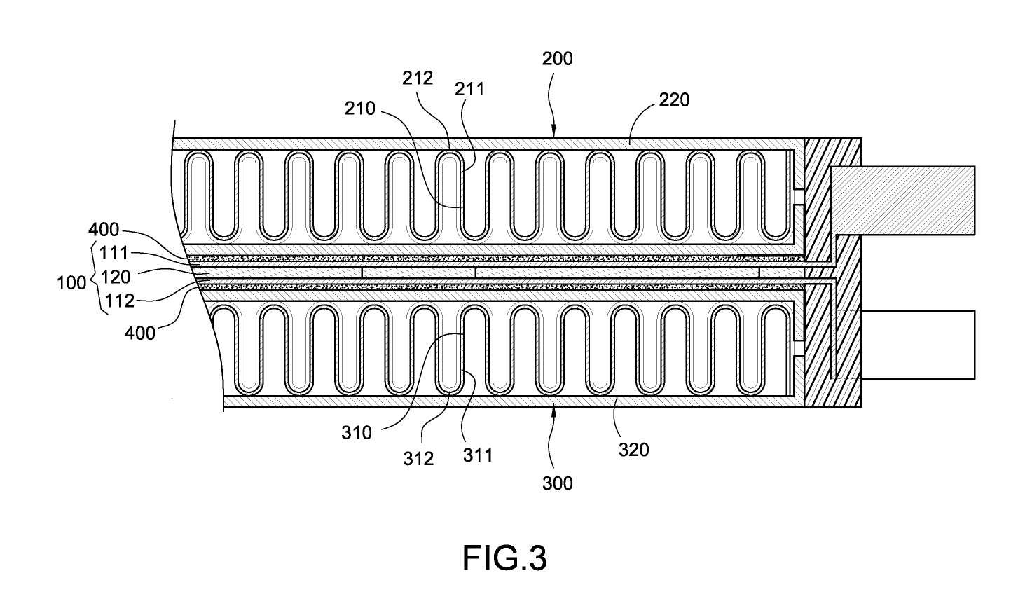

Please refer to FIGS. 1 and 3. The heating unit 100 includes two electrode plates 111/112 and a plurality of PTC heating plates 120. The electrode plates 111/112 are long strip rectangle shape metal plates, preferably made of metal having good heat conduction, such as copper or aluminum, but not limited thereto. The PTC heating plates 120 are thermistors (Positive Temperature Coefficient, PTC) preferably made of ceramics, and the PTC heating plates 120 are sandwiched between two electrode plates 111/112. In the present embodiment, the liquid state heat conduction glue 400 is spread between the PTC heating plates 120 and each electrode plate 111/112. The PTC heating plates 120 and the electrode plates 111/112 are stuck together after the heat conduction glue 400 solidifies.

Each thermal diffusion unit 200/300 includes a corrugated metal fin 210/310 and two heat conduction plates 220/320. The corrugated metal fin 210/310 is a long strip shape rectangle metal plate bent to wave form, and therefore has a plurality of peaks 212/312 which are arranged in two lines being opposite to each other. (The metal fin is preferably made of metal with good heat conduction, such as copper or aluminum, but not limited thereto) The surface of the corrugated metal fin 210/310 is provided with a repression groove 211/311 to increase the area to contact with the air. The heat conduction plate 220/320 is a long rectangle metal plate, and the corrugated metal fin 210/310 is sandwiched between the two heat conduction plates 220/320, and the two heat conduction plates 220/320 fit the peaks 212/312 on both sides of the corrugated metal fin 210/310 respectively. The heat conduction plate 220/320 is preferably made of metal with good heat conduction, such as copper or aluminum, but not limited thereto. The two thermal diffusion units 200/300 are attached to one of the electrode plates 111/112 via the heat conduction plates 220/320 respectively.

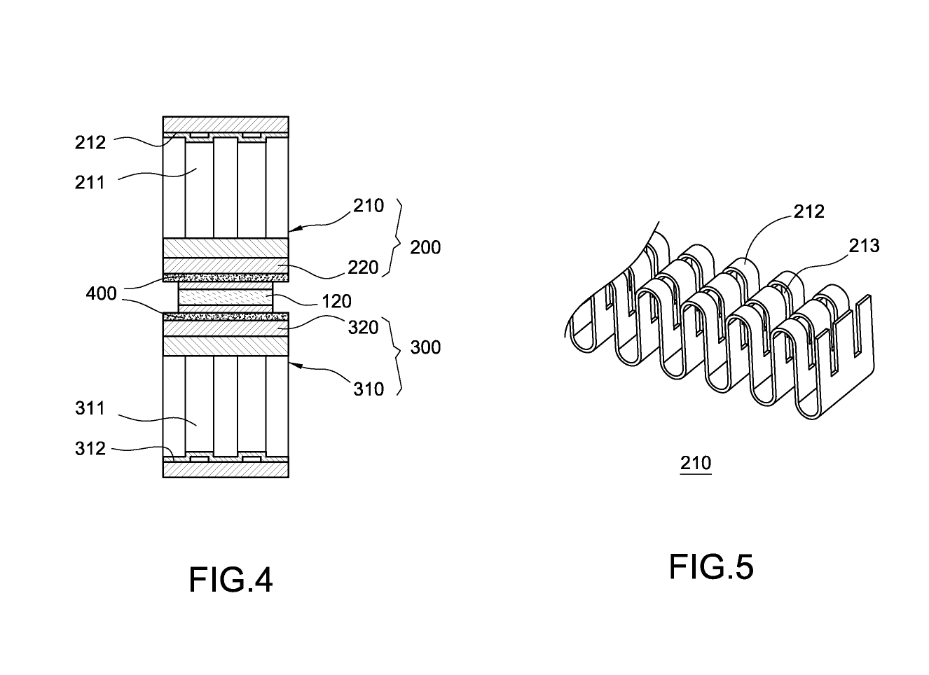

Please refer to FIG. 4. The width of the PTC heating plate 120 is preferably shorter than the width of the thermal diffusion unit 200/300. Therefore, the largest heat generating surface of the PTC heating plate 120 can totally contact the thermal diffusion unit 200/300. Preferably, the adhesive force between the heat conduction glue 400 and the surface of the aforementioned PTC heating plate 120 and the electrode plate 111/112 can be strengthened by spraying metal or anodic treatment on the surface of the aforementioned PTC heating plate 120 and the electrode plate 111/112, thereby securely connecting each component of the insulated heater of the present invention.

The place where the heat conduction glue 400 is spread is mentioned above. The composition of the heat conducting glue 400 can contain silicon, for example, the heat conducting glue 400 is silica gel. The composition of the heat conducting glue 400 can also contain plastic, for example, Teflon or polyamide. The composition of the heat conducting glue 400 can also contain epoxy. The composition of the heat conducting glue 400 can also contain ceramic powder, for example, Al₂O₃, Si₃N₄, AN, or SiC, etc.

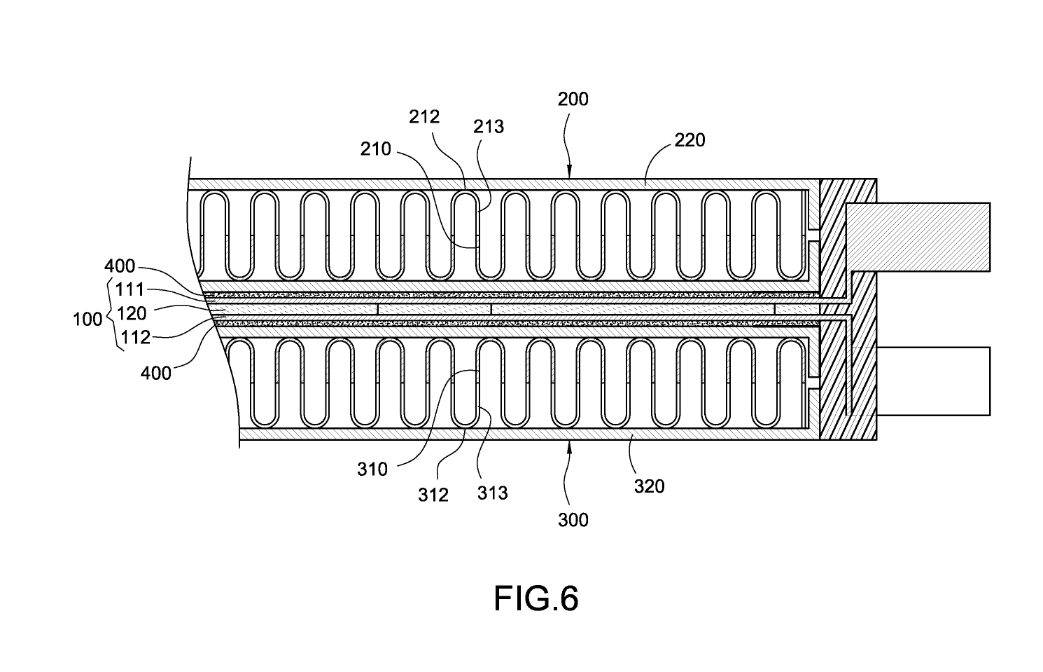

Besides, the composition of the heat conducting glue 400 can also contain mixed silicon and ceramic powder, wherein the ceramic powder is mentioned above. Moreover, the composition of the heat conducting glue 400 can also contain mixed plastic and ceramic powder, which can be epoxy and ceramic powder. Please refer to FIGS. 5 and 6. The second embodiment according to the present invention provides an insulated heater, which includes a heating unit 100, two thermal diffusion unit 200/300, and a heat conducting glue 400. The structure of the insulated heater of the present embodiment is approximately the same as the first embodiment, and the same portion will not describe hereinafter. Compared to the first embodiment, the difference of the second embodiment is that, each thermal diffusion unit 200/300 includes a corrugated metal fin 210/310 and two heat conduction plates 220/320. The corrugated metal fin 210/310 is a long strip shape rectangle metal plate bent to wave form, and therefore has a plurality of peaks 212/312 which are arranged in two lines being opposite to each other (the metal fin is preferably made of metal with good heat conduction, such as copper or aluminum, but not limited thereto). Each peak 212/312 of any one of the two lines is provided with a convection slot 213/313 to improve the air convection efficiency of the corrugated metal fin 210/310, but not limited thereto. The corrugated metal fin 210/310 can also not be provided with the convection slot 213/313 or the repression groove 211/311.

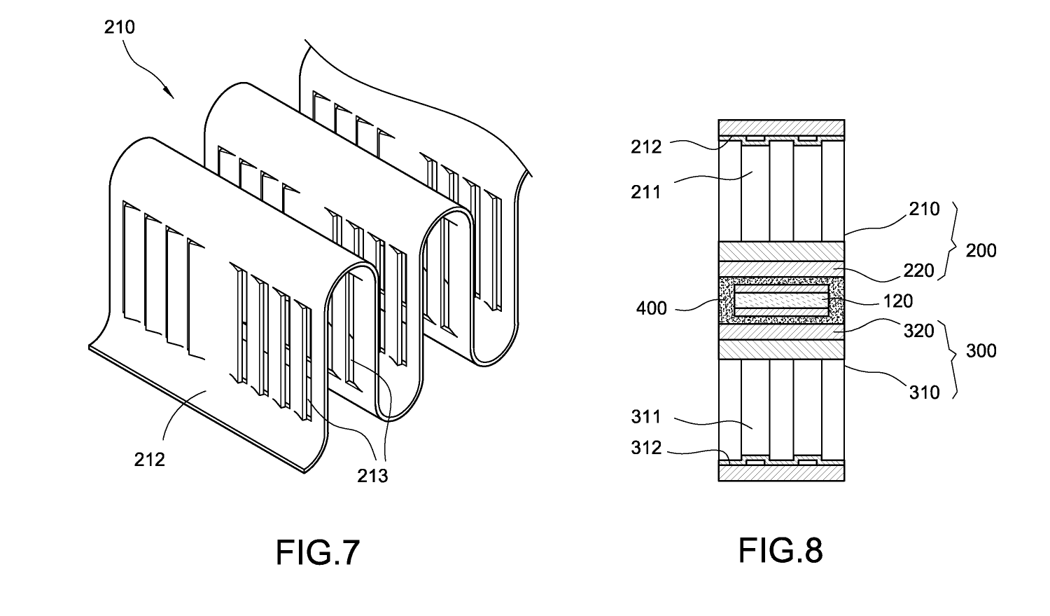

Please refer to FIG. 7. The type of the convention slot 213 is not limited in the present invention, and the convection slot 213 can also be provided between two peaks 212.

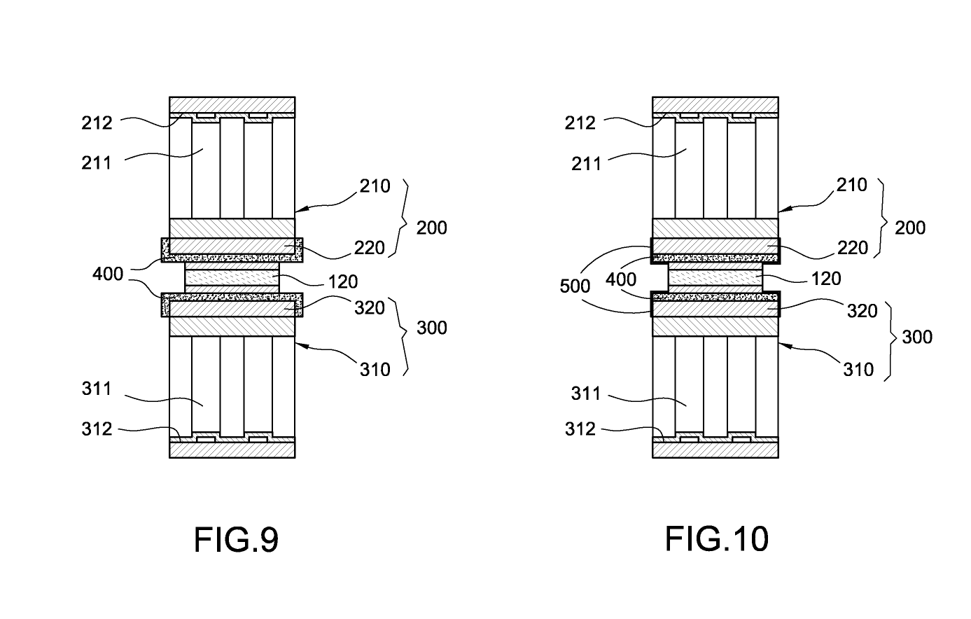

Please refer to FIG. 8. The third embodiment according to the present invention provides an insulated heater, which includes a heating unit 100, two thermal diffusion units 200/300, and a heat conducting glue 400. The structure of the insulated heater of the present embodiment is approximately the same as the first embodiment, and the same portion will not describe hereinafter. Compared to the first embodiment, the difference of the third embodiment is that, the surrounding of the heating unit 100 is covered with the heat conduction glue 400, which makes the PTC heating plate 120 to be covered with the heat conduction glue 400. By this arrangement, the PTC heating plate 120 can transmit the heat via the surrounding of the heating unit 100 to the thermal diffusion unit 200/300 to achieve better heat dissipation effect. The heat conduction glue 400 can also extend to cover the side of the heat conduction plate 220/320 (as shown in the second embodiment in FIG. 9). Furthermore, the side of the heat conduction plate 220/320 can also attach a heat conduction tape 500 to connect the heat conduction glue 400 (as shown in the third embodiment in FIG. 10).

The insulated heater according to the present invention improves the heat conduction efficiency between each component by directly sticking each component with the heat conduction glue 400. Moreover, the adhesive force of the solidified liquid heat conduction glue 400 is better than the back adhesive, thereby effectively improving the shortcomings of the conventional technique.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An insulated heater comprising:
a heating unit having two electrode plates and at least one PTC heating plate, the PTC heating plate being sandwiched between the two electrode plates;
two thermal diffusion units, each thermal diffusion unit including a corrugated metal fin and two heat conduction plates, the corrugated metal fin being sandwiched between the two heat conduction plates, the thermal diffusion units attaching to one of the electrode plates via the heat conduction plates; and
a heat conduction glue being spread between the electrode plates and the thermal diffusion units attached to the electrode plates.

2. The insulated heater according to claim 1, wherein the PTC heating plate is covered by the heat conduction glue.

3. The insulated heater according to claim 1, wherein the side of the heat conduction plate is covered with the heat conduction glue.

4. The insulated heater according to claim 1, wherein the composition of the heat conduction glue is silicon gel.

5. The insulated heater according to claim 1, wherein the composition of the heat conduction glue includes plastics.

6. The insulated heater according to claim 4, wherein the composition of the heat conduction glue includes Teflon.

7. The insulated heater according to claim 4, wherein the composition of the heat conduction glue includes polyamide.

8. The insulated heater according to claim 1, wherein the composition of the heat conduction glue includes epoxy.

9. The insulated heater according to claim 1, wherein the composition of the heat conduction glue includes ceramic powder.

10. The insulated heater according to claim 1, wherein the surface of the corrugated metal fin is provided with a repression groove.

11. The insulated heater according to claim 1, wherein the corrugated metal fin is bent and has a plurality of peaks which are arranged in two lines being opposite to each other, and a convection slot is provided between the two peaks.

12. The insulated heater according to claim 1, wherein the corrugated metal fin is bent and has a plurality of peaks which are arranged in two lines being opposite to each other, and each peak of one of the lines is provided with a convection slot respectively.

13. The insulated heater according to claim 1, wherein the surface of the PTC heating plate is processed by spraying metal.

14. The insulated heater according to claim 1, wherein the surfaces of the electrode plates are processed by anodic treatment.

15. The insulated heater according to claim 2, wherein the composition of the heat conduction glue is silicon gel.

16. The insulated heater according to claim 3, wherein the composition of the heat conduction glue is silicon gel.
